(19) United States
(12) Patent Application Publication
(10) Pub. No.: US 2020/0062471 A1
(43) Pub. Date: Feb. 27, 2020

(54) Smart Cap System And Methods Of Use

(71) Applicant: Soltan Cangoz, Ridgewood, NJ (US)

(72) Inventor: Soltan Cangoz, Ridgewood, NJ (US)

(21) Appl. No.: 16/292,638

(22) Filed: Mar. 5, 2019

Related U.S. Application Data
(60) Provisional application No. 62/721,725, filed on Aug. 23, 2018.

(51) Int. Cl. B65D 55/10; B65D 51/24; A61J 1/03; A61J 7/02; G06T 7/62

(52) U.S. Cl. CPC B65D 55/10; B65D 51/245; A61J 2200/70; A61J 7/02; G06T 7/62; A61J 1/03

(57) ABSTRACT

A smart cap is provided. The smart cap includes a base section configured to mate with and engage a top portion of a container. The smart cap includes a top section hingedly coupled to the base section. The top section is pivotable between an open position and a closed position. The smart cap includes a locking flange to interlock the base section with the top section during positioning of the top section in the closed position.

### CROSS-REFERENCE TO RELATED APPLICATIONS

This application claims the benefit of U.S. Provisional Patent Application No. 62/721,725, which was filed on Aug. 23, 2018. The entire content of the foregoing provisional patent application is incorporated herein by reference.

### BACKGROUND

Remembering to timely refill a subscription can at times be problematic, particularly for elderly patients. More importantly, the opioid crisis has increased concerns regarding medication abuse by patients. Traditional medication containers include a cap that can be easily removed at any time, allowing any number of pills to be removed. Traditional medication containers therefore provide an enclosure for storing prescription pills without providing feedback that may be helpful to patients, pharmacies and doctors.

### SUMMARY

The disclosure relates to a smart cap for a prescription container that assists the patient, pharmacy and/or doctor by monitoring the contents of the prescription container. In some embodiments, the smart cap can indicate to the patient when a refill of a prescription should be placed. In some embodiments, the smart cap can communicate directly with the pharmacy to place a refill for the prescription. In some embodiments, the smart cap can transmit data to a pharmacy and/or doctor regarding use and contents of the prescription container, allowing for monitoring of the patient to ensure abuse of medication does not occur. In some embodiments, the smart cap can include a locking mechanism to prevent opening of the prescription container when abuse of medication is determined.

In accordance with some embodiments of the present disclosure, an exemplary smart cap is provided. The smart cap comprises a base section configured to mate with and engage a top portion of a container, and a top section hingedly coupled to the base section, the top section pivotable between an open position and a closed position. The smart cap comprises a locking flange to interlock the base section with the top section during positioning of the top section in the closed position.

The base section is configured to permanently engage the top portion of the container. The locking flange is pivotably connected to the base section. The locking flange comprises a feature complementary to a feature of the top section, the features engageable to maintain the top section in the closed position. The smart cap comprises one or more visual indicators on the top section. The smart cap comprises a button extending from the top section and a switch disposed within the top section, the button electrically coupled to the switch. The smart cap comprises a sensor disposed within the top section, the sensor configured to detect whether the top portion is in the open position or the closed position.

In some embodiments, the smart cap comprises an estimation mechanism comprising a camera for capturing one or more images of the contents of the container. The smart cap comprises a processing device executable to estimate a volume of medication within the container based on the captured one or more images. In some embodiments, the smart cap comprises an estimation mechanism comprising a laser sensor to estimate a volume of medication within the container.

In some embodiments, the smart cap comprises a lockout mechanism coupled to the top section, the lockout mechanism comprising a translatable shaft. The smart cap comprises a flange extending from the base section. The flange comprises an opening configured to receive at least a portion of the shaft of the lockout mechanism to lock the top section relative to the base section. In a first position, the lockout mechanism permits rotation of the top section relative to the base section. In a second position, the shaft of the lockout mechanism engages the flange of the base section and prevents rotation of the top section relative to the base section.

In accordance with embodiments of the present disclosure an exemplary smart cap system is provided. The smart cap system comprises a container including a top portion with an opening, and a smart cap. The smart cap comprises a base section configured to mate with and engage the top portion of the container to cover the opening of the container. The smart cap comprises a top section hingedly coupled to the base section, the top section pivotable between an open position and a closed position. The smart cap comprises a locking flange to interlock the base section with the top section during positioning of the top section in the closed position.

In the open position of the top section of the smart cap, the opening of the container is exposed. The smart cap comprises one or more clips extending from the base section of the smart cap, the clips configured to permanently engage the top portion of the container to prevent removal of the smart cap from the container. The smart cap comprises an estimation mechanism comprising a camera for capturing one or more images of the contents of the container. The smart cap comprises a processing device executable to estimate a volume of medication within the container based on the captured one or more images. In some embodiments, the smart cap comprises a lockout mechanism coupled to the top section of the smart cap, the lockout mechanism comprising a translatable shaft. The smart cap comprises a flange extending from the base section of the smart cap, the flange comprising an opening configured to receive at least a portion of the shaft of the lockout mechanism to lock the top section relative to the base section.

In accordance with embodiments of the present disclosure, an exemplary method of operating a smart cap is provided. The method comprises mating and engaging a base section of the smart cap with a top portion of a container. The method comprises disengaging a locking flange from a top section of the smart cap. The method comprises pivoting the top section of the smart cap relative to the base section to expose an opening of the container.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed smart cap and system, reference is made to the accompanying figures, wherein:

FIG. 1 is a perspective front view of an exemplary smart cap system of the present disclosure;

FIG. 2 is a perspective rear view of an exemplary smart cap system of FIG. 1;

FIG. 3 is a perspective front view of an exemplary cap of a smart cap system of FIG. 1;

FIG. 4 is a perspective bottom view of an exemplary cap of a smart cap system of FIG. 1;

FIG. 5 is an exploded view of an exemplary cap of a smart cap system of FIG. 1;

FIG. 6 is a cross-sectional view of an exemplary cap of a smart cap system of FIG. 1;

FIG. 7 is a cross-sectional view of an exemplary smart cap system of FIG. 1;

FIG. 8 is a perspective front view of an exemplary cap of a smart cap system in a closed position and including a lockout mechanism;

FIG. 9 is a perspective front view of an exemplary cap of FIG. 8 in an open position;

FIG. 10 is an exploded view of an exemplary cap of FIG. 8;

FIG. 11 is a cross-sectional view of an exemplary cap of FIG. 8 including a lockout mechanism in a disengaged position;

FIG. 12 is a cross-sectional view of an exemplary cap of FIG. 8 including a lockout mechanism in an engaged position;

FIG. 13 is a cross-sectional view of an exemplary cap of FIG. 8 in an open position;

FIG. 14 is a cross-sectional view of an exemplary smart cap system including a cap of FIG. 8;

FIG. 15 is a diagrammatic, cross-sectional view of an exemplary smart cap system of the present disclosure;

FIGS. 16A-D are diagrammatic views of an estimation mechanism of an exemplary smart cap system of the present disclosure;

FIGS. 17A-B are top and side views of a container enclosure during operation of an estimation mechanism of a cap of the present disclosure indicating a full container;

FIGS. 18A-B are top and side views of a container enclosure during operation of an estimation mechanism of a cap of the present disclosure indicating a partially full container;

FIGS. 19A-B are top and side views of a container enclosure during operation of an estimation mechanism of a cap of the present disclosure indicating a nearly empty container;

FIGS. 20A-B are top and side views of a container enclosure during operation of an estimation mechanism of a cap of the present disclosure;

FIGS. 21A-B are top and side views of a container enclosure during operation of an estimation mechanism of a cap of the present disclosure;

FIGS. 22A-B are top and side views of a container enclosure during operation of an estimation mechanism of a cap of the present disclosure;

FIG. 23 is a block diagram of an exemplary smart cap system of the present disclosure;

FIG. 24 is a block diagram of an exemplary computing device for implementing the exemplary smart cap system in accordance with the present disclosure; and

FIG. 25 is a block diagram of an exemplary smart cap system environment in accordance with the present disclosure.

### DETAILED DESCRIPTION

Various terms relating to the devices, systems, methods and other aspects of the present disclosure are used throughout the specification and claims. Such terms are to be given their ordinary meaning in the art unless otherwise indicated. Other specifically defined terms are to be construed in a manner consistent with the definition provided herein.

As used in this specification and the appended claims, the singular forms “a,” “an,” and “the” include plural referents unless the content clearly dictates otherwise.

The term “more than 2” as used herein is defined as any whole integer greater than the number two, e.g., 3, 4, or 5.

The term “plurality” as used herein is defined as any amount or number greater or more than 1. In some embodiments, the term “plurality” means 2, 3, 4, 5, 6 or more.

The terms “left” or “right” are used herein as a matter of mere convenience, and are determined by standing at the rear of the machine facing in its normal direction of travel. Likewise, “forward” and “rearward” are determined by the normal direction of travel. “Upward” and “downward” orientations are relative to the ground or operating surface as are any references to “horizontal” or “vertical” planes.

The terms “substantially horizontal” or “substantially vertical” are used herein when referring to a relationship relative to a horizontal axis or plane or a vertical axis or plane, respectively. In some embodiments, “substantially horizontal” refers to equal to 0° from horizontal, or ±10°, ±5°, ±1°, ±0.5°, ±0.4°, ±0.3°, ±0.2°, ±0.1°, ±0.09°, ±0.08°, ±0.07°, ±0.06°, ±0.05°, ±0.04°, ±0.03°, ±0.02° or ±0.01° from horizontal. In some embodiments, “substantially vertical” refers to equal to 0° from vertical (e.g., a vertical plane perpendicular to horizontal), or ±10°, ±5°, ±1°, ±0.5°, ±0.4°, ±0.3°, ±0.2°, ±0.1°, ±0.09°, ±0.08°, ±0.07°, ±0.06°, ±0.05°, ±0.04°, ±0.03°, ±0.02° or ±0.01° from vertical.

The term “about” or “approximately” as used herein when referring to a measurable value such as an amount, a temporal duration, and the like, is meant to encompass variations of ±20%, ±10%, ±5%, ±1%, ±0.5%, ±0.4%, ±0.3%, ±0.2%, ±0.1%, ±0.09%, ±0.08%, ±0.07%, ±0.06%, ±0.05%, ±0.04%, ±0.03%, ±0.02% or ±0.01% from the specified value, as such variations are appropriate to perform the disclosed methods.

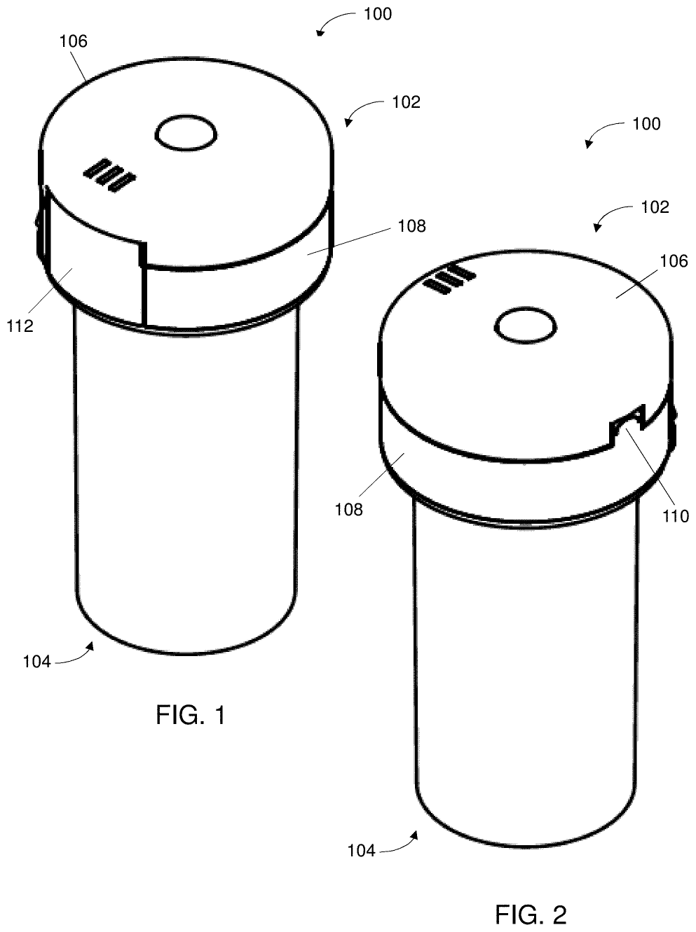

FIGS. 1 and 2 are perspective front and rear views of an exemplary smart cap system 100 (hereinafter “system 100”) of the present disclosure. The system 100 includes a smart cap 102 coupled to the top of a prescription container 104. The container 104 can be of any size used in the pharmaceutical industry, e.g., 9 dram, 13 dram, 16 dram, 20 dram, 30 dram, 40 dram, 60 dram, or the like, and the cap 102 can be dimensioned to allow for engagement between the cap 102 and container 104. The cap 102 can be fixedly coupled to the container 104 such that the cap 102 engages the top edge of the container 104 and cannot be disengaged or removed from the container 104 without physical breakage of the cap 102. Such permanent engagement of the cap 102 and container 104 prevents tampering with the contents of the container 104.

The cap 102 includes a housing formed from a top section 106 and a base section 108 hingedly coupled together at a hinge 110 disposed at the rear of the cap 102. A locking flange 112 disposed at the front of the cap 102 and pivotably extending from the base section 108 includes a feature (e.g., hook, or the like) complementary to a feature within the top section 106 of the cap 102 such that the top and base sections 106, 108 can be releasably engaged to prevent pivoting of the top section 106 at the hinge 110. Upon disengagement of the locking flange 112 from the top section 106, the top section 106 can be pivoted relative to the base section 108 to expose an opening extending into the interior of the container 104 such that medication can be retrieved. As will be discussed in greater detail below, the cap 102 includes features that monitor use of the medication to address issues of prescription refills and/or medication abuse.

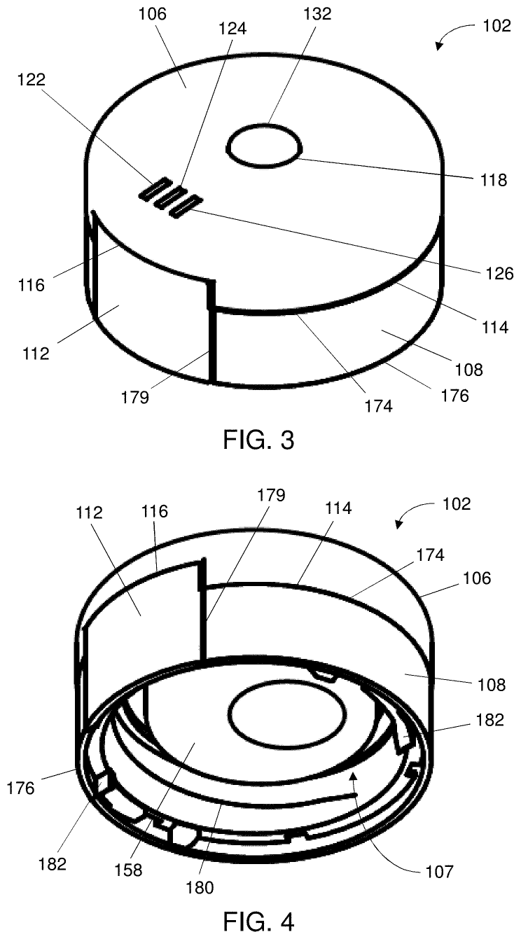

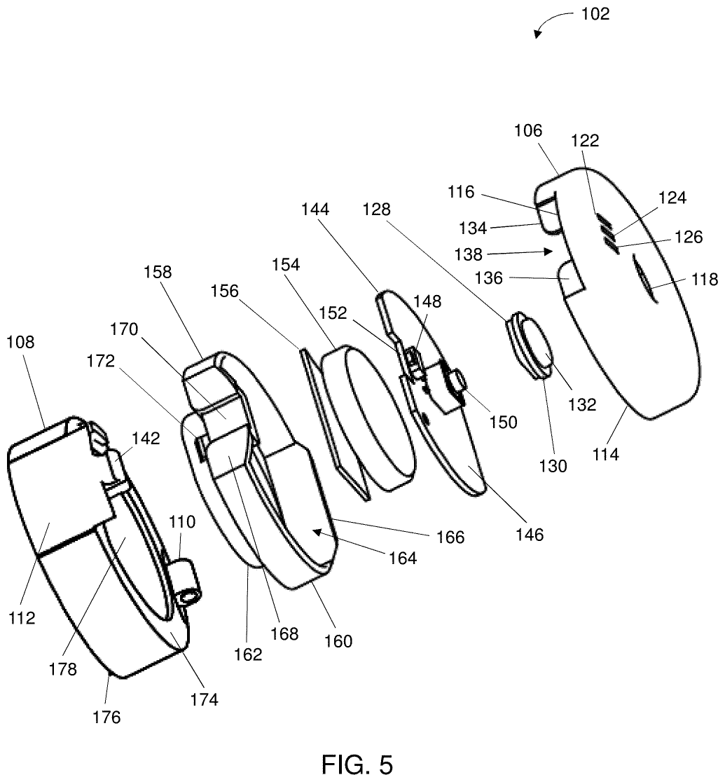

FIGS. 3-6 are perspective front, bottom, exploded and cross-sectional views of the cap 102. The top section 106 of the cap 102 can define a substantially cylindrical configuration with a rounded top edge and a substantially linear bottom edge 114. The bottom edge 114 and side of the cap 102 includes a rectangular cutout 116 configured and dimensioned to mate with the top portion of the locking flange 112. The cutout 116 extends along a partial radial distance of the top section 106. The top surface of the top section 106 includes a circular opening 118 extending therethrough along a central vertical axis 120. The top section 106 includes a substantially hollow interior 107 configured and dimensioned to act as a housing for multiple components (e.g., components shown in FIG. 5).

Offset from the central vertical axis 120, the top section 106 includes one or more light emitting diodes (LEDs) 122-126 (e.g., visual indicators). In some embodiments, the cap 102 can include three LEDs 122-126. The LEDs 122-126 can be independently or individually illuminated to provide visual feedback to the user. For example, the first LED 122 can illuminate green to indicate that the container 104 includes over a threshold amount of medication (e.g., 50% or greater by volume of the container 104). As a further example, the second LED 124 can illuminate yellow to indicate that the amount of medication is below a threshold level (e.g., less than 50% by volume of the container 104). As a further example, the third LED 126 can illuminate red to indicate that the container 104 is empty. In some embodiments, the first LED 122 can illuminate green to indicate when a prescription order has been placed. In some embodiments, the third LED 126 can illuminate red if abnormal medication use is detected and/or if the user has forgotten to take a dose of the medication by a specific time of day.

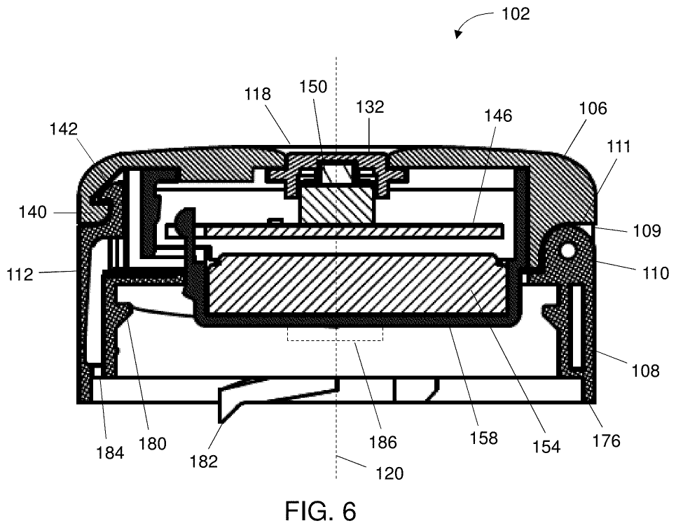

On the interior surface of the top section 106 and extending into the cutout 116, the top section 106 can include two radial flanges 134, 136 extending towards each other and a gap 138 between the two flanges 134, 136. The inner lip of the top section 106 adjacent to the gap 138 can form an inner feature 140 (e.g., a hook, or the like). The feature 140 can be complementary to the feature 142 (e.g., a hook) extending from the top surface of the locking flange 112 of the base section 108. The feature 140 of the top section 106 can extend or face inwardly, while the feature 142 of the base section 108 can extend or face outwardly such that the features 140, 142 can engage or interlock (e.g., via a snap fit) to releasably secure the top section 106 to the base section 108. Engagement of the features 140, 142 can form a childproof or child resistant lock of the cap 102. At the rear, the top section 106 can include a groove 109 configured to receive the hinge 110 of the base section 108 (see, e.g., FIG. 6). A pin 111 can pivotably couple the top section 106 to the hinge 110 of the base section 108.

The cap 102 includes a depressible button assembly 128 including a mounting plate 130 and a button 132. The button 132 can be disposed within the interior 107 of the top section 106 and extends at least partially through the opening 118 in the top section 106, allowing the user to depress the button 132 to take predetermined actions. In some embodiments, the button 132 can be depressed by the user to initiate placement of a refill of the prescription. For example, actuation of the button 132 can transmit a signal to the pharmacy and/or doctor indicating the need to refill the prescription for the user.

The cap 102 includes a printed circuit board (PCB) assembly 144 mounted within the interior 107 of the top section 106. The PCB assembly 144 includes a substantially planar PCB 146, a sensor 148 electrically coupled to the PCB 146, and a switch 150 coupled to the PCB 146. The PCB 146 includes a cutout 152 aligned with the gap 138 of the top section 106 and the feature 142 of the base section 108, such that the feature 142 passed through the cutout 152 when interlocking with the top section 106. The sensor 148 can be an open/close sensor configured to detect when the feature 142 is positioned in front of the sensor 148. In some embodiments, the sensor 148 can be an optical sensor, a contact sensor, a non-contact sensor, or the like.

When the sensor 148 detects that the feature 142 is in the cutout 152 during pivoting downward of the top section 106 toward the base section 108, the sensor 148 can transmit a signal indicating that the top section 106 is in the closed position (e.g., engaged with the base section 108). When the sensor 148 detects that the feature 142 is not in the cutout 152 during pivoting upward of the top section 106 away from the base section 108, the sensor 148 can transmit a signal indicating that the top section 106 is in the open position (e.g., disengaged from the base section 108). The electronics of the cap 102 can thereby determine when the cap 102 has been opened, the number of times the cap 102 has been opened throughout a day, or the like. Such data can be electronically stored in a database for analysis and/or monitoring.

The switch 150 (e.g., a tactile switch, or the like) can be substantially centrally mounted to the PCB 146 such that the switch 150 is aligned with the button assembly 128. Depression of the button 132 actuates the switch 150, sending an electrical signal via the PCB 146 regarding an action to be taken (e.g., transmission of a signal to a pharmacy and/or doctor requesting refilling of the prescription). The cap 102 includes a battery 154 (e.g., a button cell battery) disposed in the interior 107 below the PCB assembly 144. The battery 154 is electrically connected to the PCB assembly 144 to power the sensor 148 and switch 150. In some embodiments, an insulating plate 156 can be disposed below the battery 154.

The cap 102 includes an inner cover 158 disposed within the interior 107 of the top section 106. The cover 158 acts as a housing and surrounds the insulating plate 156, the battery 154, the PCB assembly 144, and the button assembly 128. The cover 158 includes a first or top portion 160 having substantially cylindrical or rounded sides, and a second or bottom portion 162 extending from the bottom of the top portion 160. The diameter of the top portion 160 can be dimensioned greater than the diameter of the bottom portion 162. The top portion 160 includes a substantially hollow interior 164 configured and dimensioned to receive the insulating plate 156, the battery 154, the PCB assembly 144, and the button assembly 128.

A rear side 166 of the top portion 160 can define a substantially planar or flat configuration. A front side 168 of the top portion 160 can include a channel 170 with angled sides extending towards the channel 170. The channel 170 can be aligned with the gap 138 to allow for passage of the feature 142 therethrough during opening and closure of the top section 106 relative to the base section 108. The bottom portion 162 includes an opening 172 formed therein. During assembly, the opening 172 can be aligned with the sensor 148 such that the sensor 148 can detect whether or not the feature 142 is disposed in front of the sensor 148.

The base section 108 includes a substantially planar or flat top surface 174 and a circular bottom edge 176. The base section 108 includes a radial cutout 179 configured and dimensioned to movably receive therein the locking flange 112. In some embodiments, the bottom of the locking flange 112 can be coupled to the bottom edge 176 of the base section 108 such that the locking flange 112 can pivot along the bottom edge 176 for engagement or disengagement with the top section 106. The base section 108 can include a substantially hollow inner surface 178. In some embodiments, the walls of the inner surface 178 (e.g., forming an opening) can include threads 180 configured to engage complementary threads on the outer surface of the medication container 104. The base section 108 can include a radial step 184 at or near the bottom edge 176. The base section 108 can include one or more clips 182 (e.g., perma clips) extending from the radial step 184. Each clip 182 can be configured to engage with extensions on the medication container 104 and permanently secure the cap 102 to the medication container 104.

In some embodiments, the cap 102 can include one or more estimation mechanisms 186. In some embodiments, the mechanism 186 can be centrally mounted to the cover 158 with a clear view of the interior of the mediation container 104 disposed below the cap 102 when the cap 102 is engaged with the mediation container 104. In some embodiments, the mechanism 186 mounted off-center relative to the cover 158. In some embodiments, the mechanism 186 can be in the form of a camera configured to capture images of the interior of the medication container 104. In some embodiments, the images can be analyzed to estimate the pill count within the medication container 104 to ensure that mediation abuse does not occur. In some embodiments, the images can be analyzed for integrity control (e.g., ensuring that the patient is not placing different pills inside the medication container 104 to alter the pill count). In some embodiments, the mechanism 186 can be in the form of a laser time of flight sensor. The sensor can estimate the volume or pill count within the medication container 104.

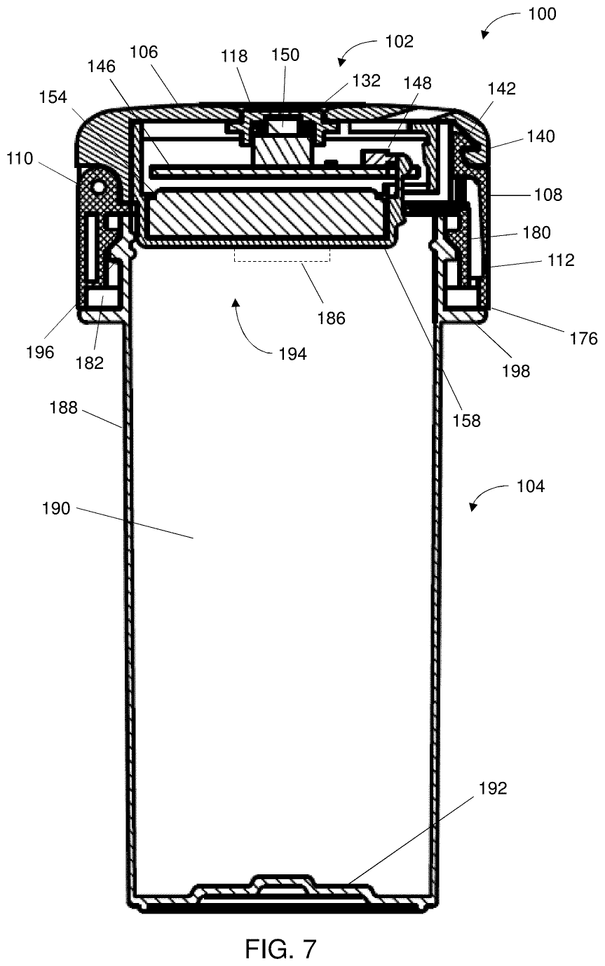

FIG. 7 is a cross-sectional view of the system 100, including the cap 102 permanently engaged with the top of the medication container 104. The container 104 can include substantially cylindrical side walls 188, a hollow enclosure or interior 190, a closed bottom surface 192, and an opening 194 at the top surface. At or near the top surface of the container 104, the container 104 can include threads 196 on the outer surface. The threads 196 can be complementary to and engage with the threads 180 on the inner surface of the base section 108 of the cap 102. Offset from the threads 196, the container 104 includes one or more outer radial flanges 198. The flanges 198 extend outwardly and perpendicularly from the walls 188. During engagement of the cap 102 with the container 104, the clips 182 of the cap 102 snap around and engage with the flanges 198 to permanently secure the cap 102 to the container 104.

To access the contents of the container 104, the top section 106 can be pivoted upwardly away from the base section 108 at the hinge 110 to expose the opening in the base section 108 and the opening 194 of the container 104. In some embodiments, the sensor 148 can transmit a signal to a central processing unit or database each time the cap 102 is opened and/or closed. Such information can be used to provide reminders to the patient regarding a forgotten dose and/or to inform the pharmacy or doctor if the contents of the container 104 are being accessed more than recommended.

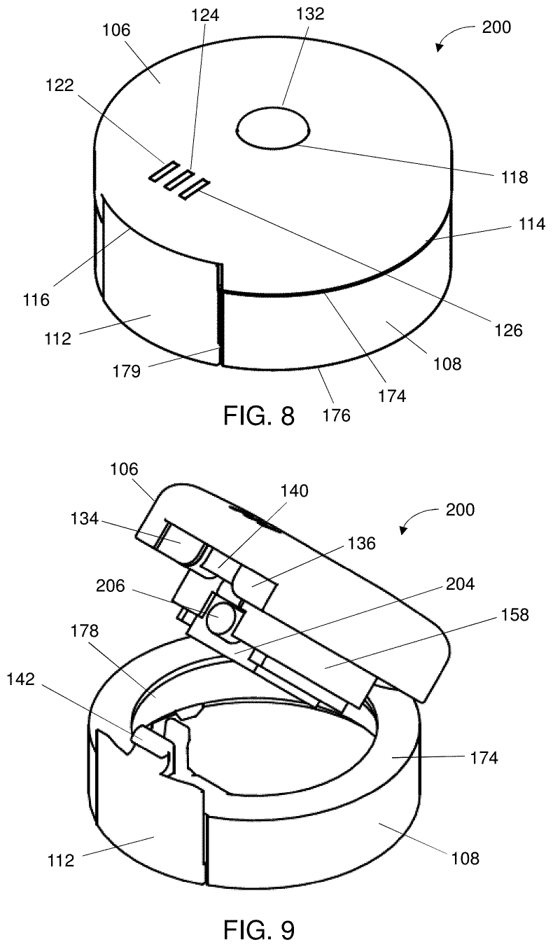

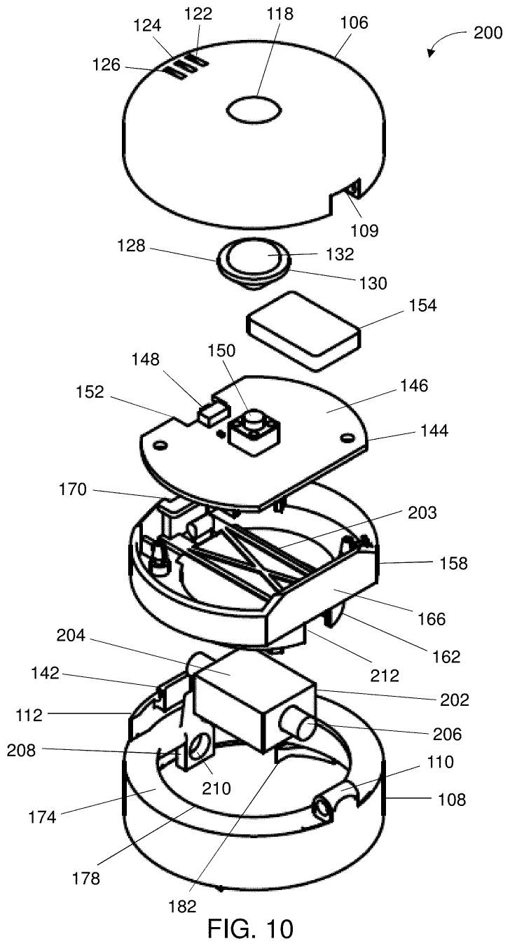

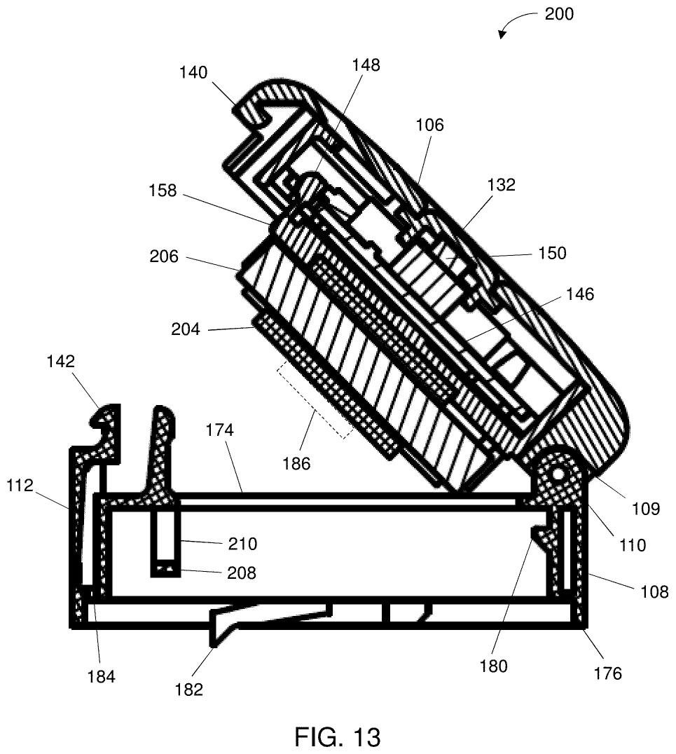

FIGS. 8-13 are perspective front, exploded and cross-sectional views of an exemplary smart cap 200 (hereinafter “cap 200”) of the present disclosure. The cap 200 can be substantially similar in structure and/or function to the cap 102, except for the distinctions noted herein. Therefore, like reference numbers are used to refer to like structures. The cap 200 can include a lockout mechanism 202 for locking the top section 106 relative to the bottom section 108 (in addition to the locking flange 112 engagement). The locking mechanism 202 can be coupled to one or more support beams 203 of the cover 148. In some embodiments, the lockout mechanism 202 can be in the form of a solenoid actuator having a body 204 and a shaft 206 slidably disposed within the body 204. The solenoid actuator can be actuated to slide the shaft 206 along the central longitudinal axis of the shaft 206. In some embodiments, the solenoid actuator can include an electromagnet with a wire coil that houses the metal shaft 206. When activated, the electromagnet becomes magnetized and pulls or translates the shaft 206 inwards or outwards along the lateral axis. Actuation of the solenoid actuator can be powered by an electrical connection to the battery 154.

The base section 106 includes a downwardly extending flange 208 at the front of the inner surface 178. The flange 208 includes a lateral opening 210 extending therethrough. The opening 210 can be configured and dimensioned to receive at least a portion of the end of the shaft 206. The bottom portion 162 of the cover 158 can include slots 212 formed on opposing front and rear sides of the cover 158. The body 204 of the lockout mechanism 202 can be mounted within the bottom portion 162 and the shaft 206 can slide in and through the respective slots 212 based on the actuation of the solenoid actuator.

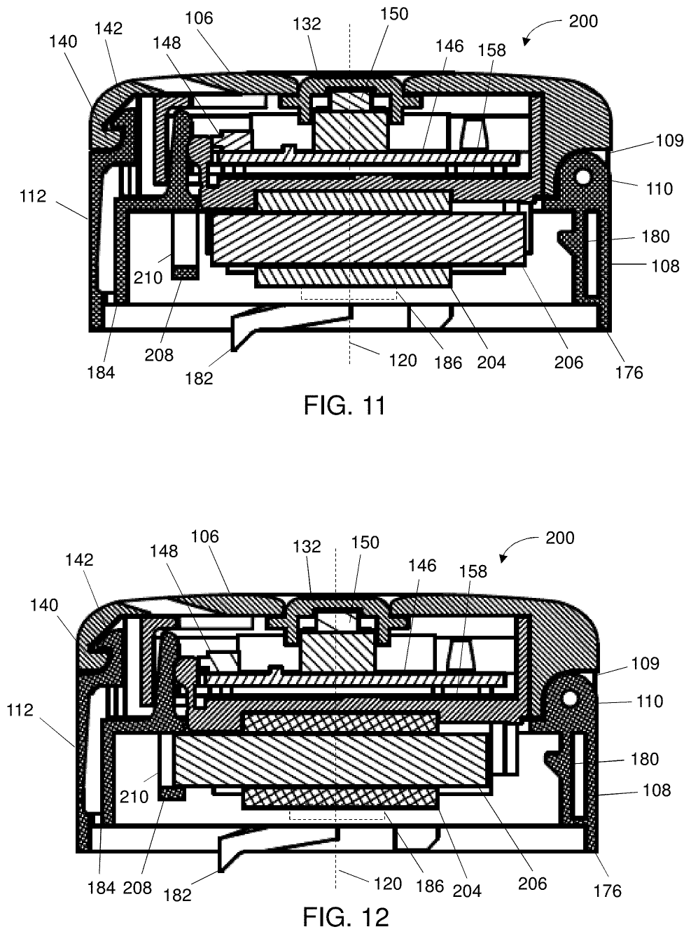

With reference to FIGS. 11 and 12, the lockout mechanism 202 can be used when the cap 200 senses and determines that medication abuse is occurring. During normal operation, the shaft 206 can be slid to the rightmost position and out of the opening 210, disengaging the shaft 206 from the base section 208. Based on the analysis from the mechanism 186, a determination can be made that the patient is consuming too many pills (e.g., at one time, over a period of time, or the like). The lockout mechanism 202 can be actuated to translate the shaft 206 to enter the opening 210 and engage with the flange 208. Due to engagement of the shaft 206 with the flange 208 of the base section 208, the top section 206 can be prevented from pivoting upwards from the base section 208 even when the locking flange 112 is disengaged. A secondary safety mechanism is thereby provided to prevent mediation abuse by patients (e.g., for substance abuse prescribers and/or clinics).

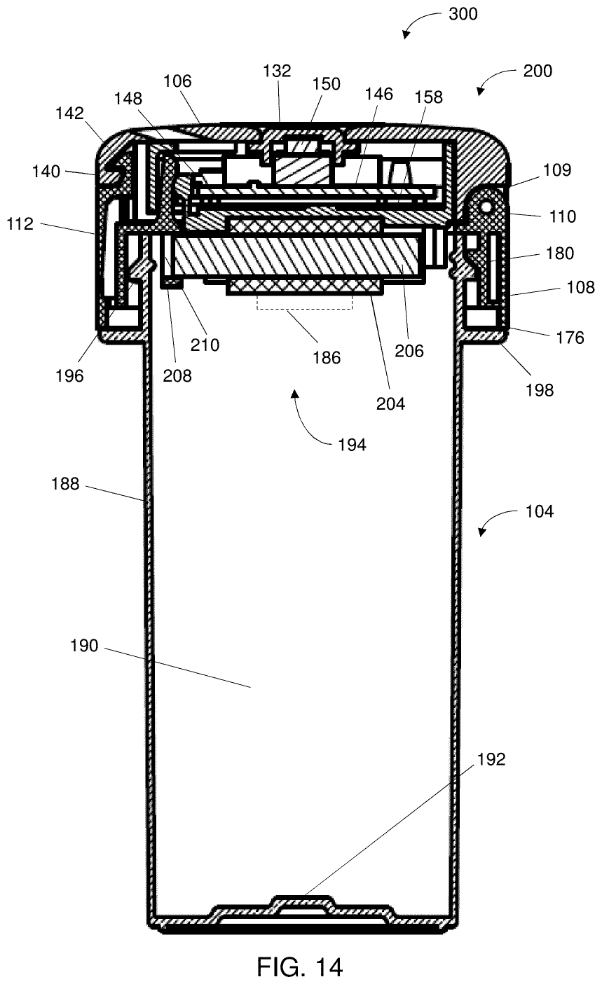

In some embodiments, the lockout mechanism 202 can be an electric lock feature that can be actuated remotely (e.g., via Bluetooth). FIG. 14 is a cross-sectional view of the cap 200 permanently engaged with the top of the container 104 (e.g., smart cap system 300).

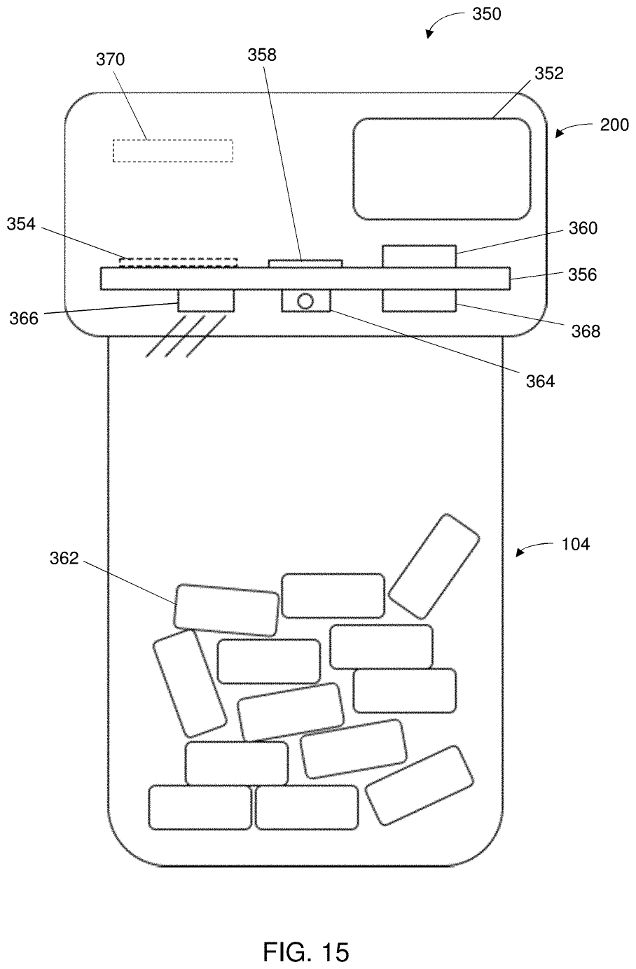

FIG. 15 is a diagrammatic, cross-sectional views of an exemplary smart cap system 350 (hereinafter “system 350”) of the present disclosure. The system 350 can be substantially similar in structure and/or function to the system 300, except for the distinctions noted herein. Therefore, like reference numbers are used to refer to like structures. The cap 200 of the system 350 includes a battery 352 connected to various components within the cap 200 to ensure proper operation of the cap 200. The cap 200 includes a processor 354 (e.g., a controller) mounted to an internal support structure 356 within the cap 200. The processor 354 can receive, transmit and/or analyze data acquired by sensors of the cap 200.

The cap 200 can include a communication component 358 (e.g., a wireless chip, an antenna, combinations thereof, or the like) for receiving and transmitting data from and to the cap 200. The communication component 358 can transmit/receive data wirelessly, via a 4G connection, or the like. In some embodiments, the data can be transmitted to/received from a cloud storage environment. In some embodiments, the cap 200 can include a gravity sensor 360 configured to detect when the system 350 and/or the cap 200 has been moved by the user. For example, the gravity sensor 360 can be used to detect when the cap 200 is opened relative to the container 104. As a further example, the gravity sensor 360 can be used to detect when the system 350 has been tilted to remove one or more pills 362.

The cap 200 can include an estimation mechanism 364 (e.g., one or more cameras) mounted to the bottom surface of the support structure 356 such that the field-of-view of the estimation mechanism 364 is directed downwards into the interior of the container 104 disposed below the cap 200. Although shows as centrally mounted to the support structure 356, it should be understood that the estimation mechanism 364 can be offset relative to a central vertical axis of the cap 200. In some embodiments, the cap 200 can include one or more light sources 366 (e.g., LEDs, or the like) mounted to the bottom surface of the support structure 356. The light sources 366 can be used to directly light into the interior of the container 104 to improve the quality and detail of the images captured by the estimation mechanism 364.

In some embodiments, the cap 200 can include an ambient light sensor 368 mounted to the bottom surface of the support structure 356 and configured to detect the illumination or light levels within the interior of the container 104. Based on the level of light within the container 104 (e.g., based on a threshold value), actuation of the light source 366 can be controlled to assist in image capture by the estimation mechanism 364. For example, if the ambient light sensor 368 detects that the light level is below a predetermined threshold value, the processor 354 can actuate the light source 366 to illuminate the interior of the container 104 prior to and during capture of one or more images by the estimation mechanism 364. The estimation mechanism 366 can thereby capture accurate representation of the contents of the container 104 in any ambient light setting. A removable storage device 370 (e.g., a SIM card, or the like) can be used to electronically store data collected by sensors associated with the cap 200.

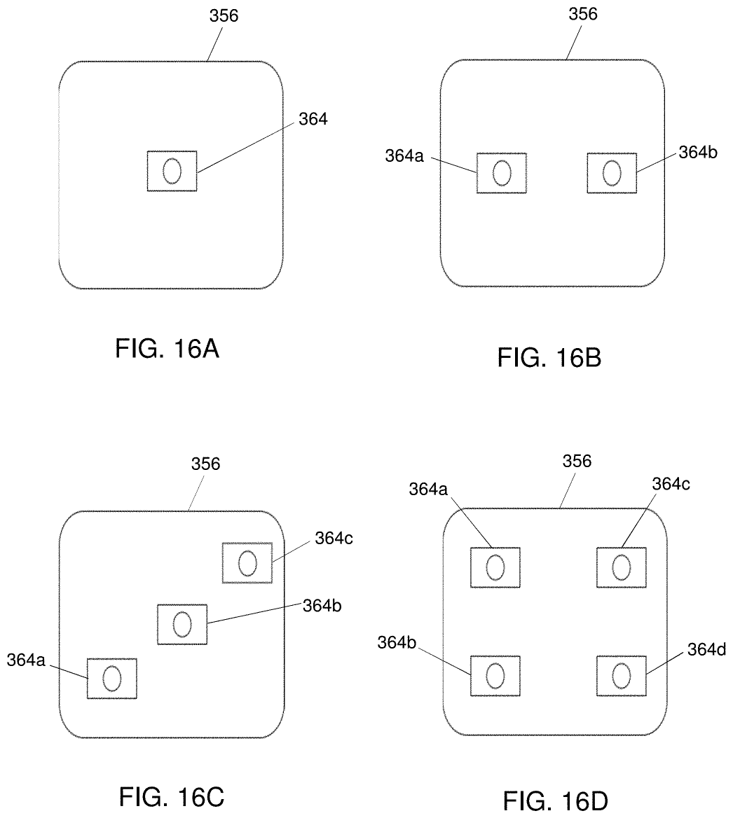

FIGS. 16A-D are diagrammatic views of an estimation mechanism mounted to a support structure within the smart cap. Particularly, FIGS. 16A-D illustrate different configurations and positioning of the estimation mechanism. For example, as shown in FIG. 16A, a single estimation mechanism 164 can be used. In some embodiments, the estimation mechanism 164 can be centered. In some embodiments, the estimation mechanism 164 can be offset from the central point or axis. As shown in FIG. 16B, in some embodiments, two estimation mechanism 364a-b can be used to capture images of the interior of the container 104 from multiple angles. As shown in FIG. 16C, in some embodiments, three estimation mechanisms 364a-c arranged in a diagonal configuration can be used. As shown in FIG. 16D, in some embodiments, four estimation mechanisms 364a-d arranged near respective corners of the support structure 356 can be used. It should be understood that FIGS. 16A-D merely show examples of different estimation mechanism configurations, and alternative arrangements are also contemplated.

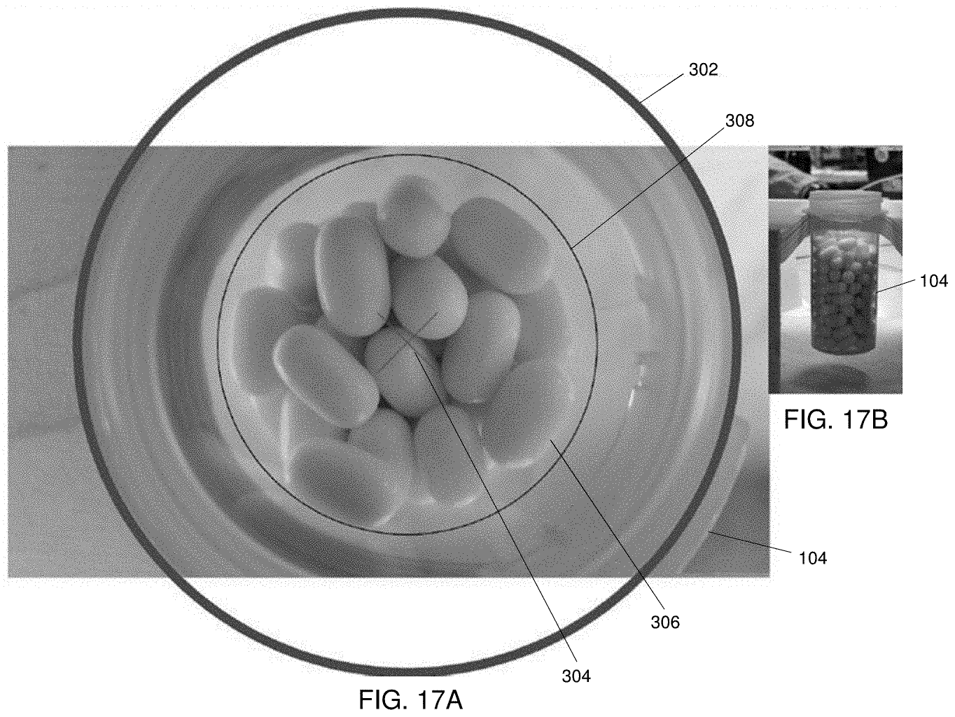

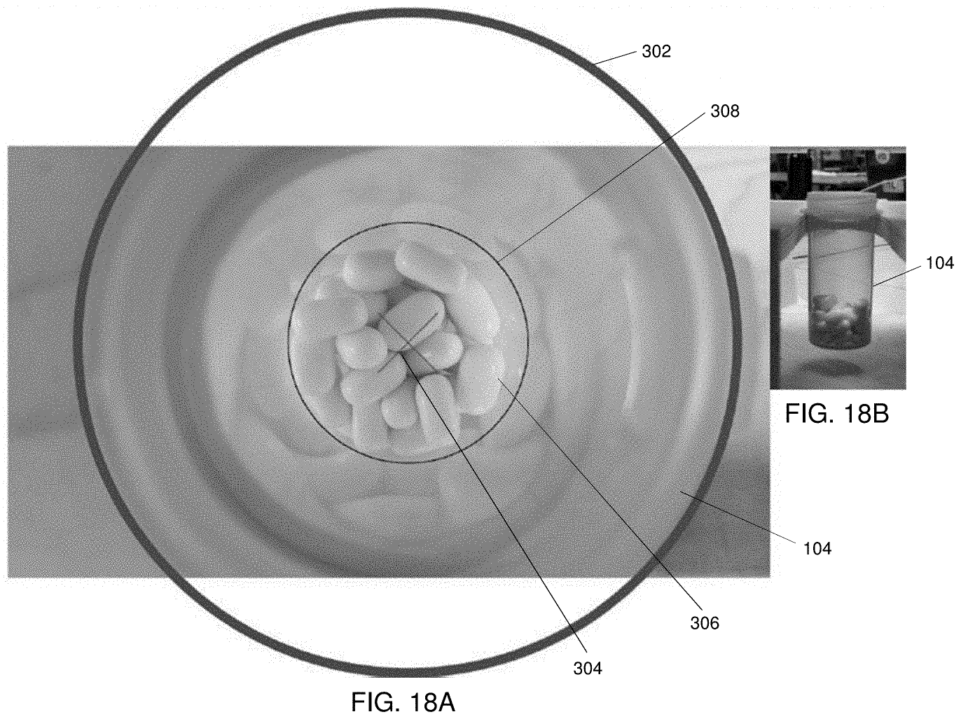

FIGS. 15A-22B are top and side views of interior of the container 104 during different stages of operation of the estimation mechanism. The estimation mechanism can capture images of the contents of the container 104 at predetermined intervals of time (e.g., twice a day, once a day, every hour, or the like) to estimate the number of pills remaining in the container 104. FIG. 17A shows an image captured by the camera of the estimation mechanism when the container 104 is substantially full of pills 306, and FIG. 17B shows a side view of the container 104 for reference.

A reference circle 302 can be generated based on the circular configuration of the container 104. Crosshairs 304 can be generated based on the center of the reference circle 302 (e.g., center of the container 104). An estimation circle 308 can be generated, emanating from the central crosshairs 304 to the outermost pill 306. Particularly, the estimation circle 308 can be generated based on the outermost edge of the outermost pill 306, and is generally concentric relative to the container 104 and the reference circle 302. The diameter of the estimation circle 308 (e.g., the area calculated from the diameter) can be correlated with the fullness of the container 104. For example, the estimation circle 308 of FIG. 17A can act as a baseline measurement of the full container 104, and subsequent areas of estimation circles 308 can be compared to the estimation circle 308 of FIG. 17A to determine the rate of consumption of the pills 306.

FIG. 18A shows a partially full container 104. Although the reference circle 302 remains of the same diameter as in FIG. 17A, the diameter of the estimation circle 308 is dimensioned smaller than the estimation circle 308 of FIG. 17A due to the reduction in the number of pills 306, resulting in a smaller area of the estimation circle 308. Particularly, the reduced number of pills 306 in the container 104 is lower and further from the estimation mechanism, resulting in a smaller estimation circle 308 due to the field-of-view or perspective of the camera.

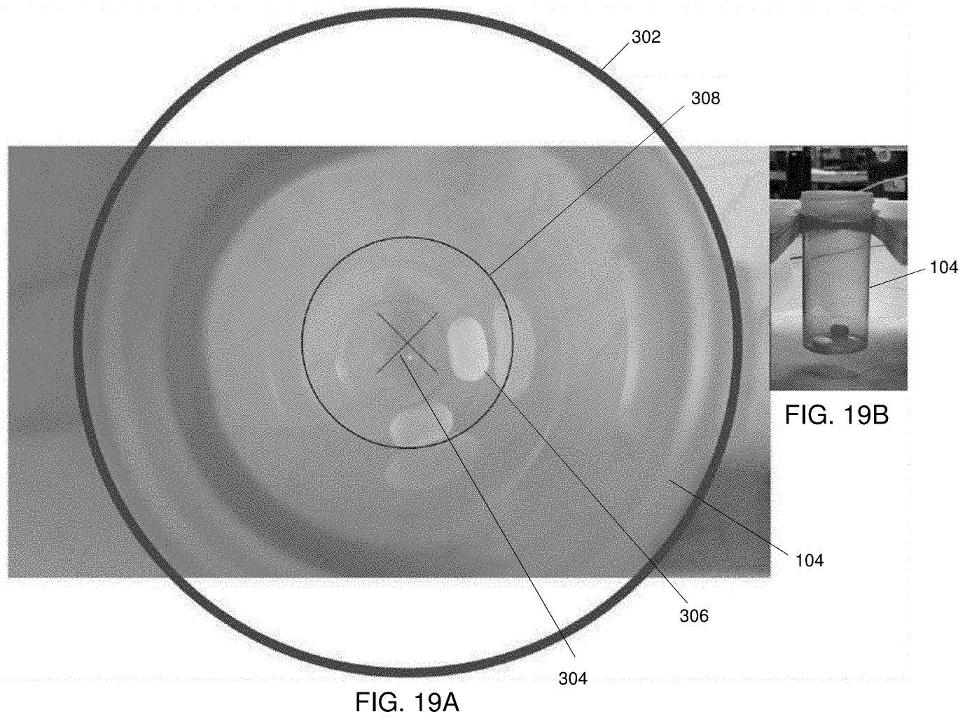

FIG. 19A shows a substantially empty container 104 having only two pills 306 remaining. The diameter of the estimation circle 308 in FIG. 19A is dimensioned smaller than the estimation circle 308 of FIG. 18A, indicating that the number of pills 306 in the container 104 is significantly reduced relative to the number in FIG. 17A. The number of pills 306 in the container 104 can thereby be estimated over predetermined periods of time to prevent medication abuse or estimate when the user should be reminded of requesting a refill.

In some embodiments, upon detection of the number of pills 306 reaching a predetermined threshold value (e.g., 10 pills, or the like), the smart cap can automatically transmit a request to a pharmacy for a refill of the prescription (e.g., if refills of the prescription remain). In some embodiments, upon detection of the number of pills 306 reaching a predetermined threshold value (e.g., 10 pills, or the like), the smart cap can transmit a message to the user's mobile device indicating that a refill request should be initiated. In some embodiments, upon detection of the number of pills 306 reaching a predetermined threshold value (e.g., 10 pills, or the like), the smart cap can illuminate one or more visual indicators of the smart cap (e.g., with a continuous illumination, with a flashing illumination, with illumination of a particular color, or the like) to indicate that a refill request should be initiated.

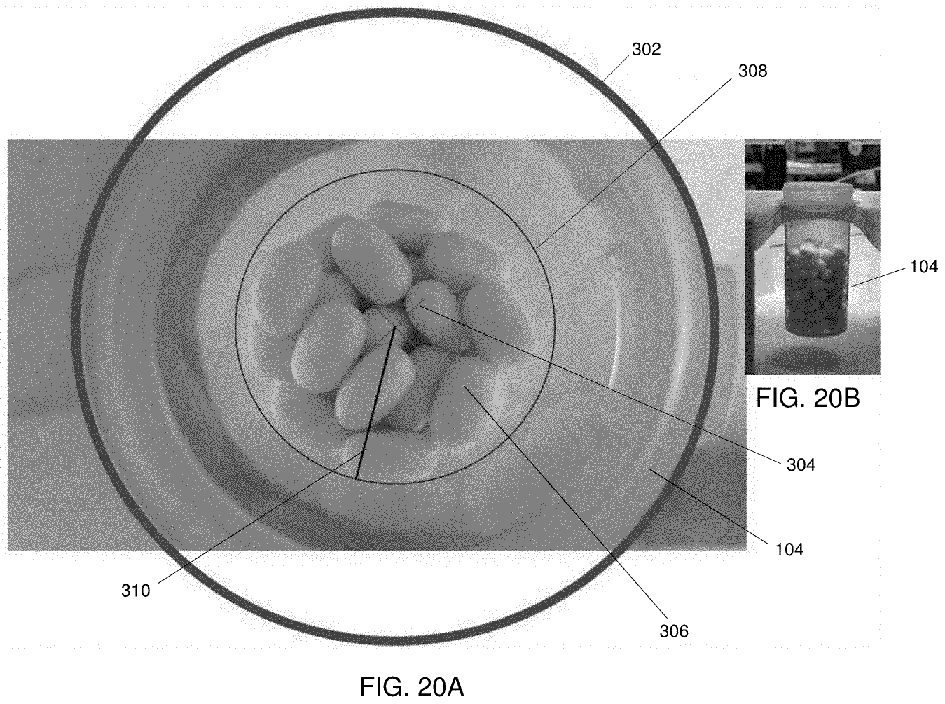

FIGS. 20A-B show an alternative operation of the estimation mechanism. In some embodiments, rather than generating an estimation circle 308 based on the outermost pill 306, a radius line 310 extending from the center of the container 104 (e.g., the crosshairs 304) to the edge of the outermost pill 306. Based on the dimension of the radius line 310, the estimation circle 308 can be generated and the number of pills 306 within the container 104 can be estimated.

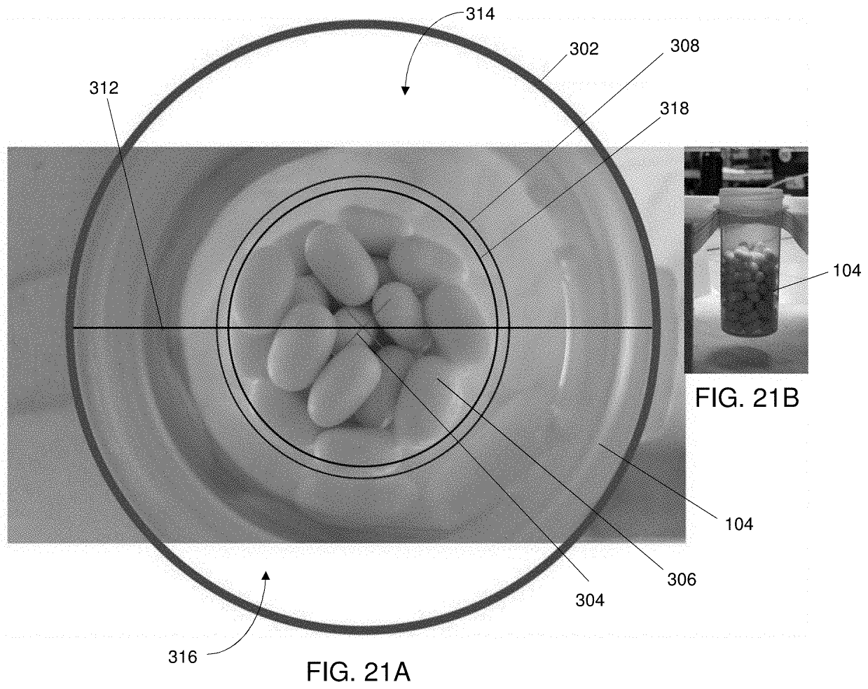

FIGS. 21A-B show an alternative operation of the estimation mechanism. In some embodiments, the area defined by the reference circle 302 can be divided into one or more segments using separation lines 312. For example, one or more separation lines 312 can be used. As shown in FIG. 21A, the separation line 312 divides the area defined by the reference circle 302 into first and second segments 314, 316. An estimation circle 308, 318 can be generated for each segment 314, 316 individually and independently based on any of the methods discussed herein. For example, estimation circle 308 is generated for the first segment 314 based on the outermost edge of the outermost pill 306 in the first segment 314. Similarly, estimation circle 318 is generated for the second segment 316 based on the outermost edge of the outermost pill 306 in the second segment 316. An estimate for the number of pills 306 (or fill level of the container 104) can be performed for each estimation circle 308, 318, and an average value can be determined as the output pill 306 or fill level estimate. It should be understood that the greater number of separation lines 312 used, the higher the accuracy of the output estimation.

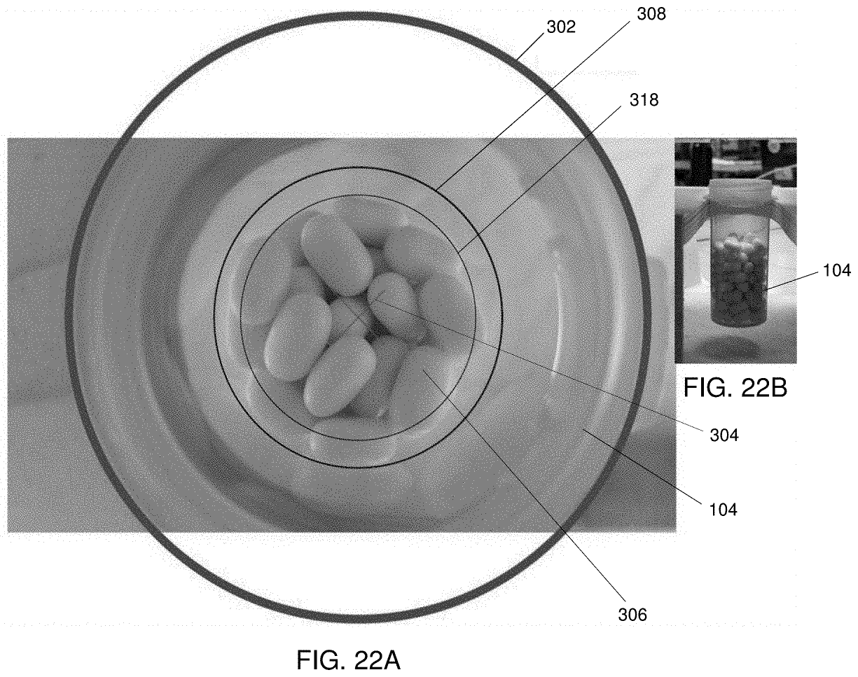

FIGS. 22A-B show an alternative operation of the estimation mechanism. Rather than generating separation lines 312, the estimation mechanism can automatically generate two or more estimation circles 308, 318 based on predetermined segments (e.g., quadrants) associated with the reference circle 302 and the outermost edge of the outermost pill 306 in each segment. For example, the inner estimation circle 318 can be estimated at approximately 194.91 pixels, and the outer estimation circle 308 can be estimated at approximately 235.4 pixels. An average of the two estimation circles 308, 318 can be approximately 210.95 pixels, which can correlate with approximately 89 pills 506. In some embodiments, artificial intelligence can be used with computer vision technology in a machine learning method to “teach” the estimation mechanism to recognize fill levels of the container 104. Over time, historical data can be used to improve the overall accuracy of estimation.

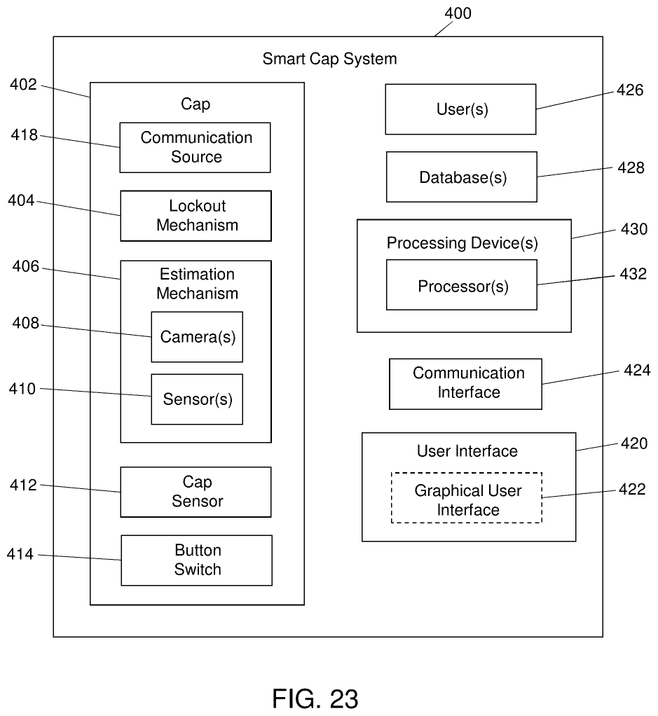

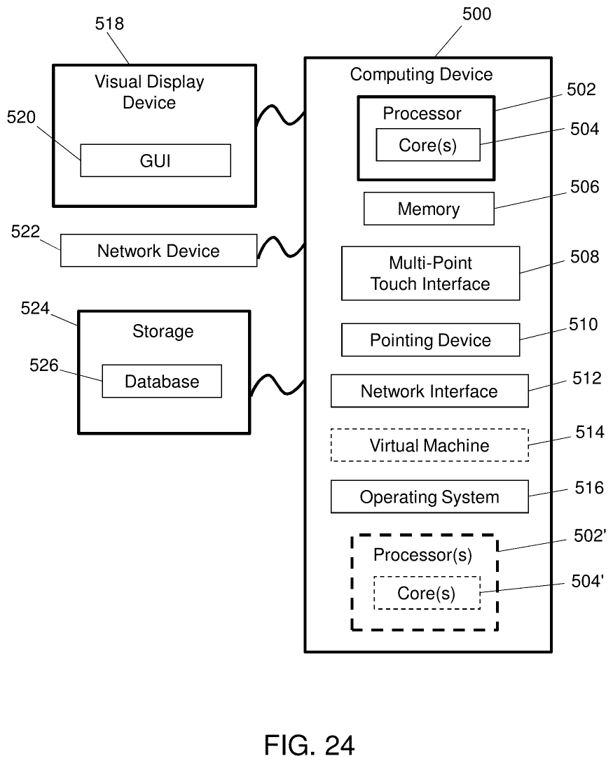

FIG. 23 is a block diagram of an exemplary smart cap system 400 (hereinafter “system 400”). The system 400 can include a smart cap 402 (e.g., cap 102, cap 200, or the like). It should be understood that the cap 402 can be used with any type of container (e.g., container 104). The cap 402 can include a lockout mechanism 404 to prevent opening of the cap 200 when medication abuse is detected. The cap 402 can include an estimation mechanism 406 to estimate the number of pills remaining in a container. In some embodiments, the estimation mechanism 406 can include one or more cameras 408 to capture images of the contents of the container, the images analyzed to estimate the number of pills by volume remaining in the container. In some embodiments, the estimation mechanism 406 can include one or more sensors 410 (e.g., a laser time-of-flight sensor) to measure the distance from the sensor 410 to the uppermost pill to estimate the number of pills by volume remaining in the container. In some embodiments, the estimation mechanism 406 can include both a camera 408 and a sensor 410.

The cap 402 can include a cap sensor 412 to detect when the top section of the cap 402 has been opened and/or closed relative to the base section. The cap 402 can include a button switch 414 for actuation by the user via a button at the top of the cap 402. For example, the button switch 414 can be actuated to automatically place a refill order of the prescription for the patient. The cap 402 can include a communication source 416 (e.g., a receiver, transmitter, combinations thereof, or the like). The communication source 416 allows the cap 402 to connect to a user interface 420 having a graphical user interface (GUI) 422 via a communication interface 424 such that data collected by the components of the cap 402 can be analyzed and used (e.g., to lock the cap 402, automatically order a prescription refill, or the like).

In some embodiments, the communication interface 424 can be Bluetooth, WiFi, a cellular connection, a low energy source, or the like. The user interface 420 can be on a device of the patient, pharmacy and/or doctor (e.g., users 426). In some embodiments, the cap 402 can communicate with an iOS application, Android application, or the like. In some embodiments, based on data collected by the cap 402, the cap 402 can transmit text message reminders to the patient when a dose has been missed. In some embodiments, a location tracker (e.g., global positioning system) on the user's portable device can be used to track the location of the user and cap 402.

In some embodiments, the user interface 420 can be a monitoring portal for a physician, a monitoring portal for a pharmacist, a monitoring portal for a patient approved caretaker, a monitoring portal for a patient, or the like. The portal can provide real-time or substantially real-time data regarding medication adherence of patients, documentations made by a pharmacist or caretaker, reminders regarding missed doses of the medication, communication between the patient and pharmacist and/or physician, or the like. In some embodiments, the system 400 can be used to collect data from pharmacy billing hubs, compare such information to the patient medication adherence data collected from the cap 402 to assist healthcare providers, pharmacies, insurance companies, or the like, to monitor, track and enforce fraud, waste and abuse of medications. The data collected by the cap 402 and input at the user interface 420 can be collected and electronically stored in one or more databases 428. In some embodiments, the databases 428 can be part of the cap 402 and/or external to the cap 402. The system 400 can include one or more processing devices 430 having one or more processors 432 as part of the cap 402 and/or external to the cap 402. The processing devices 430 can receive as input and analyze the data collected by the system 400.

FIG. 24 is a block diagram of a computing device 500 in accordance with exemplary embodiments of the present disclosure. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 506 included in the computing device 500 may store computer-readable and computer-executable instructions or software for implementing exemplary embodiments of the present disclosure (e.g., instructions for operating one or more components of the cap, instructions for operating the user interface, instructions for operating the communication interface, combinations thereof, or the like). The computing device 500 also includes configurable and/or programmable processor 502 and associated core 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device 500 may be shared dynamically. A virtual machine 514 may be provided to handle a process running on multiple processors so that the process appears to be using only one computing resource rather than multiple computing resources. Multiple virtual machines may also be used with one processor. Memory 506 may include a computer system memory or random access memory, such as DRAM, SRAM, EDO RAM, and the like. Memory 506 may include other types of memory as well, or combinations thereof.

A user may interact with the computing device 500 through a visual display device 518 (e.g., a personal computer, a mobile smart device, or the like), such as a computer monitor, which may display at least one user interface 520 (e.g., a graphical user interface) that may be provided in accordance with exemplary embodiments. The computing device 500 may include other I/O devices for receiving input from a user, for example, a camera, a keyboard, a fingerprint scanner, microphone, or any suitable multi-point touch interface 508, a pointing device 510 (e.g., a mouse). The keyboard 508 and the pointing device 510 may be coupled to the visual display device 518. The computing device 500 may include other suitable conventional I/O peripherals.

The computing device 500 may also include at least one storage device 524, such as a hard-drive, CD-ROM, eMMC (MultiMediaCard), SD (secure digital) card, flash drive, non-volatile storage media, or other computer readable media, for storing data and computer-readable instructions and/or software that implement exemplary embodiments of the smart caps described herein. Exemplary storage device 524 may also store at least one database 526 for storing any suitable information required to implement exemplary embodiments. For example, exemplary storage device 524 can store at least one database 526 for storing information, such as data relating to cap positions, estimated pill count, estimated pill volume, combinations thereof, or the like, and computer-readable instructions and/or software that implement exemplary embodiments described herein. The databases 526 may be updated by manually or automatically at any suitable time to add, delete, and/or update one or more items in the databases.

The computing device 500 can include a network interface 512 configured to interface via at least one network device 522 with one or more networks, for example, a Local Area Network (LAN), a Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 512 may include a built-in network adapter, a network interface card, a PCMCIA network card, Pa CI/PCIe network adapter, an SD adapter, a Bluetooth adapter, a card bus network adapter, a wireless network adapter, a USB network adapter, a modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the tablet computer), mobile computing or communication device (e.g., the smart phone communication device), an embedded computing platform, or other form of computing or telecommunications device that is capable of communication and that has sufficient processor power and memory capacity to perform the operations described herein.

The computing device 500 may run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 516 may be run in native mode or emulated mode. In an exemplary embodiment, the operating system 516 may be run on one or more cloud machine instances.

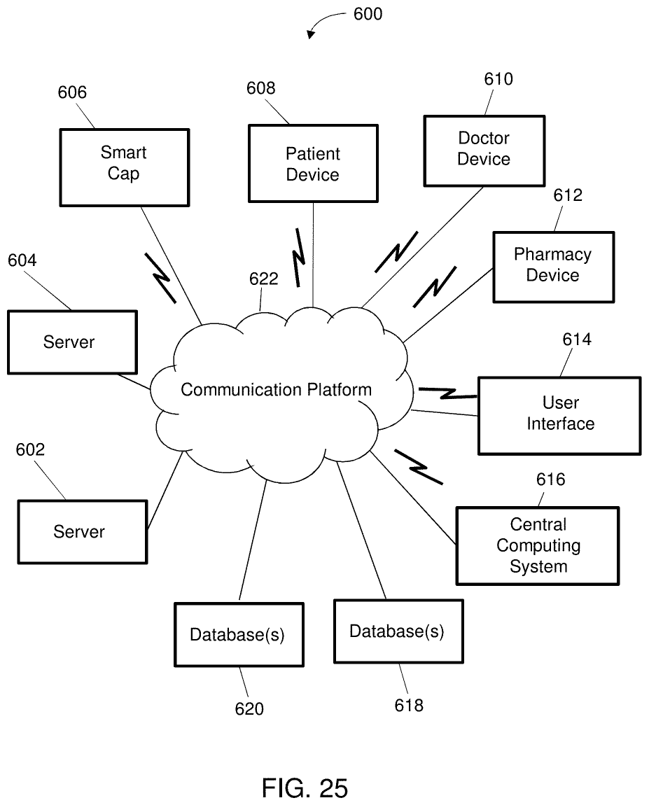

FIG. 25 is a block diagram of an exemplary smart cap system environment 600 in accordance with exemplary embodiments of the present disclosure. The environment 600 can include servers 602, 604 configured to be in communication with at least one smart cap 606, at least one patient device 608, at least one doctor device 610, at least one pharmacy device 612, at least one user interface 614, a central computing system 616, combinations thereof, or the like, via a communication platform 622, which can be any network over which information can be transmitted between devices communicatively coupled to the network. For example, the communication platform 622 can be the Internet, Intranet, virtual private network (VPN), wide area network (WAN), local area network (LAN), and the like. In some embodiments, the communication platform 622 can be part of a cloud environment.

The environment 600 can include repositories or databases 618, 620, which can be in communication with the servers 602, 604, as well as the at least one smart cap 606, at least one patient device 608, at least one doctor device 610, at least one pharmacy device 612, at least one user interface 614, and central computing system 616, via the communications platform 622.

In exemplary embodiments, the servers 602, 604, the at least one smart cap 606, at least one patient device 608, at least one doctor device 610, at least one pharmacy device 612, at least one user interface 614, and central computing system 616 can be implemented as computing devices (e.g., computing device 500). Those skilled in the art will recognize that the databases 618, 620 can be incorporated into at least one of the servers 602, 604. In some embodiments, the databases 618, 620 can store data relating to probe images, enrollment data, authentication data, combinations thereof, or the like, and such data can be distributed over multiple databases 618, 620.

While exemplary embodiments have been described herein, it is expressly noted that these embodiments should not be construed as limiting, but rather that additions and modifications to what is expressly described herein also are included within the scope of the present disclosure. Moreover, it is to be understood that the features of the various embodiments described herein are not mutually exclusive and can exist in various combinations and permutations, even if such combinations or permutations are not made express herein, without departing from the spirit and scope of the present disclosure.

1. A smart cap, comprising:
a base section configured to mate with and engage a top portion of a container;
a top section hingedly coupled to the base section, the top section pivotable between an open position and a closed position; and
a locking flange to interlock the base section with the top section during positioning of the top section in the closed position.

2. The smart cap of claim 1, wherein the base section is configured to permanently engage the top portion of the container.

3. The smart cap of claim 1, wherein the locking flange is pivotably connected to the base section.

4. The smart cap of claim 1, wherein the locking flange comprises a feature complementary to a feature of the top section, the features engageable to maintain the top section in the closed position.

5. The smart cap of claim 1, comprising one or more visual indicators on the top section.

6. The smart cap of claim 1, comprising a button extending from the top section and a switch disposed within the top section, the button electrically coupled to the switch.

7. The smart cap of claim 1, comprising a sensor disposed within the top section, the sensor configured to detect whether the top portion is in the open position or the closed position.

8. The smart cap of claim 1, comprising an estimation mechanism including a camera for capturing one or more images of the contents of the container.

9. The smart cap of claim 8, comprising a processing device executable to estimate a volume of medication within the container based on the captured one or more images.

10. The smart cap of claim 1, comprising an estimation mechanism including a laser sensor to estimate a volume of medication within the container.

11. The smart cap of claim 1, comprising a lockout mechanism coupled to the top section, the lockout mechanism comprising a translatable shaft.

12. The smart cap of claim 11, comprising a flange extending from the base section, the flange comprising an opening configured to receive at least a portion of the shaft of the lockout mechanism to lock the top section relative to the base section.

13. The smart cap of claim 12, wherein in a first position, the lockout mechanism permits rotation of the top section relative to the base section.

14. The smart cap of claim 13, wherein in a second position, the shaft of the lockout mechanism engages the flange of the base section and prevents rotation of the top section relative to the base section.

15. A smart cap system, comprising:
a container including a top portion with an opening; and
a smart cap, the smart cap comprising:
a base section configured to mate with and engage the top portion of the container to cover the opening of the container;
a top section hingedly coupled to the base section, the top section pivotable between an open position and a closed position; and
a locking flange to interlock the base section with the top section during positioning of the top section in the closed position.

16. The smart cap system of claim 15, wherein in the open position of the top section of the smart cap, the opening of the container is exposed.

17. The smart cap system of claim 15, comprising one or more clips extending from the base section of the smart cap, the clips configured to permanently engage the top portion of the container to prevent removal of the smart cap from the container.

18. The smart cap system of claim 15, comprising an estimation mechanism including a camera for capturing one or more images of the contents of the container, and a processing device executable to estimate a volume of medication within the container based on the captured one or more images.

19. The smart cap system of claim 15, comprising a lockout mechanism coupled to the top section of the smart cap, the lockout mechanism comprising a translatable shaft, and further comprising a flange extending from the base section of the smart cap, the flange comprising an opening configured to receive at least a portion of the shaft of the lockout mechanism to lock the top section relative to the base section.

20. A method of operating a smart cap, comprising:
mating and engaging a base section of the smart cap with a top portion of a container;
disengaging a locking flange from a top section of the smart cap; and
pivoting the top section of the smart cap relative to the base section to expose an opening of the container.
